(19) United States
(12) Patent Application Publication
(10) Pub. No.: US 2026/0265518 A1
(43) Pub. Date: Sep. 10, 2026

(54) BLENDED LIQUID FORMULATION FOR CONTINUOUS PRODUCTION OF BIODEGRADABLE POLYMERS

(71) Applicant: Intrinsic Advanced Materials, LLC, Gastonia, NC (US)

(72) Inventors: Robert Alton Usher, JR., Charlotte, NC (US); Julia Renee Logan, Charlotte, NC (US)

(73) Assignee: Intrinsic Advanced Materials, LLC, Gastonia, NC (US)

(21) Appl. No.: 19/491,378

(22) PCT Filed: Jun. 6, 2024
(86) PCT No.: PCT/US2024/032722

§ 371 Date: Dec. 8, 2025

Related U.S. Application Data
(60) Provisional application No. 63/472,093, filed on Jun. 9, 2023.

(51) Int. Cl. C08L 67/04; B65D 1/40; B65D 25/20; C08L 67/02; D01F 1/10; D01F 6/92

(52) U.S. Cl. CPC C08L 67/04; B65D 1/40; B65D 25/20; C08L 67/02; D01F 1/10; D01F 6/92; C08L 2201/06; C08L 2203/12; C08L 2205/025; C08L 2205/035; C08L 2310/00; D10B 2331/041; D10B 2505/10

(57) ABSTRACT

Embodiments of the present disclosure are directed to a blended liquid biodegradable textile additive. The additive includes caprolactone monomer, polyethylene glycol, calcium carbonate, and an antioxidant. The blended liquid biodegradable textile additive is formulated to be transported in a liquid additive container.

### CROSS-REFERENCE TO RELATED APPLICATIONS

This application claims priority to U.S. Provisional Patent Application No. 63/472,093, filed Jun. 9, 2023, the entire contents of which application are hereby incorporated by reference.

### TECHNOLOGICAL FIELD

Embodiments of the present disclosure relate generally to biodegradable polymer compositions suitable for textiles and, more particularly, to blended liquid formulations of biodegradable polymer compositions.

### BACKGROUND

Textiles are fundamental to human culture and have been made and used for thousands of years. The earliest known textiles were woven from natural fibers such as flax, wool, silk, and cotton. More recently, textile fibers, yarns, and fabrics also have been industrially produced from polymers, such as polyester, nylon, olefins, other thermoplastic polymers, and combinations thereof. Many modern polymers may be made into an almost endless variety of shapes and products that are attractive, durable, and water-resistant. In many cases, these synthetic fibers or yarns (depending upon the desired technique and end product) may be blended with natural fibers to obtain end products with desired features of both natural and synthetic materials, such as durability and water-resistance.

Although durability and water-resistance are desirable, these same properties may lead to secondary environmental problems. Textiles produced from polymeric fibers do not naturally biodegrade in the same manner as natural fibers and may remain in landfills and water (e.g., lakes, oceans, etc.) for hundreds of years or more. According to the United States Environmental Protection Agency, almost 44 million pounds of synthetic (polymeric) textiles go to landfills on a daily basis. In addition, a large portion of the microfibers that are released from garments during the laundry wash cycle are caught in wastewater treatment plant sludge. The sludge is eventually turned out as biosolids that are sent to landfill or used as fertilizer. These polymeric microfibers then accumulate in soil or other ground environments, and may even become mobile, eventually making their way from terrestrial to aquatic environments. According to some estimates, around half a million tons of plastic microfibers resulting from the washing of textiles are released into the ocean on an annual basis. Certain high surface area microfibers may absorb large toxin loads and resemble microscopic plankton, thereby ending up bio accumulated in the food chain by several orders of magnitude. In turn, because humans typically consume top predator species, such microfiber pollution may negatively affect human health.

As additional issues, items such as carpet and upholstery (both residential and commercial) are bulky relative to garments, and typically incorporate larger, bulkier yarns, and thus may occupy significant landfill space.

In the non-woven context, the now ubiquitous “wipes” of all types (typically a non-woven sheet or several ply sheet) likewise take up significant space, and may also have a tendency, even when considered “flushable,” to clog municipal sewage systems, particularly given the increasing use of low volume, low flow commodes.

In view of these environmental problems, the creation of biodegradable polymers has been the subject of intense academic and industrial interest.

Biodegradable fibers currently available further present various issues in their manufacture. Typically, to form biodegradable polymers, a masterbatch approach is used. The biodegradable polymers may then be fed through an extruder or a continuous polymerization line. However, masterbatch and extrusion are costly, requiring additional compounding, drying, and crystallization steps. Further, polycaprolactone (Mw of 6400), a known biodegradable polymer, in pellet form is well-suited to a masterbatch approach; however, it is more difficult to use in a continuous polymerization process.

Further, transporting materials to form the biodegradable polymers is difficult, both in terms of bulkiness and cost. All materials must be transported separately and then combined during the continuous polymerization process. Biodegradable fiber manufacturers must individually source each material, whether from the same supplier or independent suppliers.

Accordingly, there is a need for biodegradable polymers suitable for forming textiles with desirable properties analogous to traditional textiles, which may be formed via continuous production (e.g., continuous polymerization), rather than masterbatch production, and formulated in such a way to improve ease of transport.

### BRIEF SUMMARY

One or more embodiments of the invention may address one or more of the aforementioned problems. Certain embodiments according to the invention provide additives, systems, methods, and kits for forming biodegradable textiles. In particular, according to a first aspect, a blended liquid biodegradable textile additive is provided. The additive includes caprolactone monomer, polyethylene glycol, calcium carbonate, and an antioxidant.

In accordance with certain embodiments, the additive may comprise 50-80 wt % caprolactone monomer. In some embodiments, the additive may comprise 15-25 wt % polyethylene glycol. In certain embodiments, the additive may comprise 0.4-2 wt % calcium carbonate. In further embodiments, the additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

According to certain embodiments, a biodegradable textile composition may be provided. The biodegradable textile composition may include terephthalic acid, ethylene glycol, the blended liquid biodegradable textile additive, and polybutylene succinate. In some embodiments, the composition may comprise 800-10,000 ppm polybutylene succinate. In further embodiments, the composition may comprise 0.4-1.2 wt % of the blended liquid biodegradable textile additive.

In accordance with certain embodiments, a biodegradable polyester copolymer filament made from the biodegradable textile composition may be provided.

According to certain embodiments, a textured biodegradable polyester copolymer filament made from the biodegradable polyester copolymer filament may be provided.

In accordance with certain embodiments, a textured biodegradable polyester copolymer staple fiber made from the textured biodegradable polyester copolymer filament may be provided.

According to certain embodiments, a fabric made from the textured biodegradable polyester copolymer staple fiber may be provided. In some embodiments, the fabric may be a woven fabric. In certain embodiments, the fabric may be a knitted fabric. In further embodiments, the fabric may be a nonwoven fabric.

In accordance with certain embodiments, a garment made from the fabric may be provided.

According to certain embodiments, a fabric made from the biodegradable polyester filament may be provided.

In another aspect, a system of transporting a blended biodegradable textile additive is provided. The system includes a liquid additive container and a blended liquid biodegradable textile additive disposed in the liquid additive container. The additive comprises caprolactone monomer, polyethylene glycol, calcium carbonate, and an antioxidant.

In accordance with certain embodiments, the liquid additive container may comprise a plastic container having an open end, a steel cage housing the plastic container, a lid removable coupled to the open end of the plastic container, and a valve disposed in a wall of the plastic container configured to release the blended liquid biodegradable textile additive from the plastic container. The lid may have an exterior-facing surface and an interior-facing surface, and a propeller may be disposed on the interior-facing surface of the lid. In some embodiments, the valve may be a ball valve. In certain embodiments, the liquid additive container may be mounted on a pallet. In further embodiments, the pallet may comprise plastic.

In accordance with certain embodiments, the additive may comprise 50-80 wt % caprolactone monomer. In some embodiments, the additive may comprise 15-25 wt % polyethylene glycol. In certain embodiments, the additive may comprise 0.4-2 wt % calcium carbonate. In further embodiments, the additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

In yet another aspect, a method of transporting a blended liquid biodegradable textile additive is provided. The method includes forming a blended liquid biodegradable textile additive, transferring the blended liquid biodegradable textile additive to a liquid additive container having a lid and a propeller disposed on an interior-facing surface of the lid, placing the liquid additive container containing the blended liquid biodegradable textile additive therein on a transport vehicle, and agitating the blended liquid biodegradable textile additive via the propeller during transport. The blended liquid biodegradable textile additive comprises caprolactone monomer, polyethylene glycol, calcium carbonate, and an antioxidant.

According to certain embodiments, forming the blended liquid biodegradable textile additive may comprise blending the caprolactone monomer, polyethylene glycol, calcium carbonate, and the antioxidant under agitation. In some embodiments, transferring the blended liquid biodegradable textile additive to the liquid additive container may comprise pumping the blended liquid biodegradable textile additive into the liquid additive container.

In accordance with certain embodiments, the additive may comprise 50-80 wt % caprolactone monomer. In some embodiments, the additive may comprise 15-25 wt % polyethylene glycol. In certain embodiments, the additive may comprise 0.4-2 wt % calcium carbonate. In further embodiments, the additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

In yet another aspect, a method of spinning a biodegradable polyester copolymer filament is provided. The method includes esterifying raw materials comprising terephthalic acid and ethylene glycol to form an esterification mixture, adding a blended liquid biodegradable textile additive to the esterification mixture, polymerizing the blended liquid biodegradable textile additive and the esterification mixture to form a polymerization mixture, combining polybutylene succinate with the raw materials, the esterification mixture, or the polymerization mixture such that a biodegradable polyester copolymer melt is formed after the polymerization step, and spinning the biodegradable polyester copolymer melt into the biodegradable polyester copolymer filament. The blended liquid biodegradable textile additive comprises caprolactone monomer, polyethylene glycol, calcium carbonate, and an antioxidant.

According to certain embodiments, the method may further comprise extruding polybutylene succinate to form an extruded polybutylene succinate to be combined with the esterification mixture or the polymerization mixture. In some embodiments, adding the blended liquid biodegradable textile additive to the esterification mixture may comprise dispensing the blended liquid biodegradable textile additive from a liquid additive container. In certain embodiments, polymerizing the blended liquid biodegradable textile additive and the esterification mixture may be carried out on a continuous polymerization line. In other embodiments, polymerizing the blended liquid biodegradable textile additive and the esterification mixture may be carried out on a batch reactor. In some embodiments, polymerizing the blended liquid biodegradable textile additive and the esterification mixture occurs at a temperature from about 265° C. to about 295° C.

In accordance with certain embodiments, the additive may comprise 50-80 wt % caprolactone monomer. In some embodiments, the additive may comprise 15-25 wt % polyethylene glycol. In certain embodiments, the additive may comprise 0.4-2 wt % calcium carbonate. In further embodiments, the additive may comprise 0.01-1 wt % antioxidant. In some embodiments, the composition may comprise 800-10,000 ppm polybutylene succinate. In further embodiments, the composition may comprise 04-1.2 wt % of the blended liquid biodegradable textile additive.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

According to certain embodiments, a method of forming a fabric from the biodegradable polyester copolymer filament may be provided.

According to certain embodiments, a method of forming a textured biodegradable polyester copolymer filament may be provided. The method may comprise texturing the biodegradable polyester copolymer filament to form the textured biodegradable polyester copolymer filament.

In accordance with certain embodiments, a method of forming a textured biodegradable polyester copolymer staple fiber may be provided. The method may comprise cutting the textured biodegradable polyester copolymer filament to form a textured biodegradable polyester copolymer staple fiber.

According to certain embodiments, a method of forming a textured biodegradable polyester chip may be provided. The method may comprise granulizing the textured biodegradable polyester copolymer filament to form a textured biodegradable polyester chip.

In accordance with certain embodiments, a method of forming a textured biodegradable polyester container may be provided. The method may comprise blow-molding the textured biodegradable polyester copolymer to form a textured biodegradable polyester container.

According to certain embodiments, a method of forming a textured biodegradable polyester wrap may be provided. The method may comprise blow-molding the textured biodegradable polyester copolymer to form a textured biodegradable polyester wrap.

In accordance with certain embodiments, a method of forming a textured biodegradable polyester copolymer yarn may be provided. The method may comprise spinning the textured biodegradable polyester copolymer staple fiber to form a yarn.

According to certain embodiments, a method of forming a textured biodegradable polyester copolymer blended yarn may be provided. The method may comprise spinning the textured biodegradable polyester copolymer staple fiber with one or more of cotton fiber and rayon fiber to form a blended yarn.

In accordance with certain embodiments, a method of forming a fabric from the textured biodegradable polyester copolymer staple fiber may be provided. In some embodiments, forming the fabric may comprise knitting the textured biodegradable polyester copolymer staple fiber to form the fabric. In other embodiments, forming the fabric may comprise weaving the textured biodegradable polyester copolymer staple fiber to form the fabric. In further embodiments, forming the fabric may comprise forming a nonwoven fabric. In certain embodiments, a method of forming a garment from the fabric is provided.

In yet another aspect, a kit for spinning a biodegradable polyester copolymer filament is provided. The kit includes a liquid additive container containing a blended liquid biodegradable textile additive, polybutylene succinate, terephthalic acid, and ethylene glycol. The blended liquid biodegradable textile additive comprises caprolactone monomer, polyethylene glycol, calcium carbonate, and an antioxidant.

In accordance with certain embodiments, the additive may comprise 50-80 wt % caprolactone monomer. In some embodiments, the additive may comprise 15-25 wt % polyethylene glycol. In certain embodiments, the additive may comprise 0.4-2 wt % calcium carbonate. In further embodiments, the additive may comprise 0.01-1 wt % antioxidant.

According to certain embodiments, the kit may comprise 800-10,000 ppm polybutylene succinate. In further embodiments, the kit may comprise 0.4-1.2 wt % additive.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

In yet another aspect, a blended liquid biodegradable textile additive is provided. The additive includes caprolactone monomer, polyethylene glycol, ethylene glycol, and an antioxidant.

In accordance with certain embodiments, the blended liquid biodegradable textile additive may comprise 50-80 wt % caprolactone monomer. In some embodiments, the blended liquid biodegradable textile additive may comprise 15-25 wt % polyethylene glycol. In certain embodiments, the blended liquid biodegradable textile additive may comprise 0.4-2 wt % ethylene glycol. In further embodiments, the blended liquid biodegradable textile additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

According to certain embodiments, a biodegradable textile composition may be provided. The biodegradable textile composition may include terephthalic acid, ethylene glycol, the blended liquid biodegradable textile additive, and a solid system additive. The solid system additive may comprise polybutylene succinate and calcium carbonate. In some embodiments, the solid system additive may comprise 91-94 wt % polybutylene succinate. In further embodiments, the solid system additive may comprise 6-9 wt % calcium carbonate. In some embodiments, the composition may comprise 0.4-1.2 wt % of the blended liquid biodegradable textile additive. In further embodiments, the composition may comprise 0.1-1.5 wt % solid system additive.

In accordance with certain embodiments, a biodegradable polyester copolymer filament made from the biodegradable textile composition may be provided.

According to certain embodiments, a textured biodegradable polyester copolymer filament made from the biodegradable polyester copolymer filament may be provided.

In accordance with certain embodiments, a textured biodegradable polyester copolymer staple fiber made from the textured biodegradable polyester copolymer filament may be provided.

According to certain embodiments, a fabric made from the textured biodegradable polyester copolymer staple fiber may be provided. In some embodiments, the fabric may be a woven fabric. In certain embodiments, the fabric may be a knitted fabric. In further embodiments, the fabric may be a nonwoven fabric.

In accordance with certain embodiments, a garment made from the fabric may be provided.

According to certain embodiments, a fabric made from the biodegradable polyester filament may be provided.

In another aspect, a system of transporting a blended biodegradable textile additive is provided. The system includes a liquid additive container and a blended liquid biodegradable textile additive disposed in the liquid additive container. The additive comprises caprolactone monomer, polyethylene glycol, ethylene glycol, and an antioxidant.

In accordance with certain embodiments, the liquid additive container may comprise a plastic container having an open end, a steel cage housing the plastic container, a lid removable coupled to the open end of the plastic container, and a valve disposed in a wall of the plastic container configured to release the blended liquid biodegradable textile additive from the plastic container. The lid may have an exterior-facing surface and an interior-facing surface, and a propeller may be disposed on the interior-facing surface of the lid. In some embodiments, the valve may be a ball valve. In certain embodiments, the liquid additive container may be mounted on a pallet. In further embodiments, the pallet may comprise plastic.

In accordance with certain embodiments, the blended liquid biodegradable textile additive may comprise 50-80 wt % caprolactone monomer. In some embodiments, the blended liquid biodegradable textile additive may comprise 15-25 wt % polyethylene glycol. In certain embodiments, the blended liquid biodegradable textile additive may comprise 0.4-2 wt % ethylene glycol. In further embodiments, the blended liquid biodegradable textile additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

In yet another aspect, a method of transporting a blended liquid biodegradable textile additive is provided. The method includes forming a blended liquid biodegradable textile additive, transferring the blended liquid biodegradable textile additive to a liquid additive container having a lid and a propeller disposed on an interior-facing surface of the lid, placing the liquid additive container containing the blended liquid biodegradable textile additive therein on a transport vehicle, and agitating the blended liquid biodegradable textile additive via the propeller during transport. The blended liquid biodegradable textile additive comprises caprolactone monomer, polyethylene glycol, ethylene glycol, and an antioxidant.

According to certain embodiments, forming the blended liquid biodegradable textile additive may comprise blending the caprolactone monomer, polyethylene glycol, ethylene glycol, and the antioxidant under agitation. In some embodiments, transferring the blended liquid biodegradable textile additive to the liquid additive container may comprise pumping the blended liquid biodegradable textile additive into the liquid additive container.

In accordance with certain embodiments, the blended liquid biodegradable textile additive may comprise 50-80 wt % caprolactone monomer. In some embodiments, the blended liquid biodegradable textile additive may comprise 15-25 wt % polyethylene glycol. In certain embodiments, the blended liquid biodegradable textile additive may comprise 0.4-2 wt % ethylene glycol. In further embodiments, the blended liquid biodegradable textile additive may comprise 0.01-1 wt % antioxidant.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

In another aspect, a method of spinning a biodegradable polyester copolymer filament is provided. The method includes esterifying raw materials comprising terephthalic acid and ethylene glycol to form an esterification mixture, adding a blended liquid biodegradable textile additive to the esterification mixture, polymerizing the blended liquid biodegradable textile additive and the esterification mixture to form a polymerization mixture, combining a solid system additive with the raw materials, the esterification mixture, or the polymerization mixture such that a biodegradable polyester copolymer melt is formed after the polymerization step, and spinning the biodegradable polyester copolymer melt into the biodegradable polyester copolymer filament. The blended liquid biodegradable textile additive comprises caprolactone monomer, polyethylene glycol, ethylene glycol, and an antioxidant. The solid system additive comprises polybutylene succinate and calcium carbonate.

According to certain embodiments, the method may further comprise extruding the solid system additive to form an extruded solid system additive to be combined with the esterification mixture or the polymerization mixture. In some embodiments, adding the blended liquid biodegradable textile additive to the esterification mixture may comprise dispensing the blended liquid biodegradable textile additive from a liquid additive container. In certain embodiments, polymerizing the blended liquid biodegradable textile additive and the esterification mixture may be carried out on a continuous polymerization line. In other embodiments, polymerizing the blended liquid biodegradable textile additive and the esterification mixture may be carried out on a batch reactor. In some embodiments, polymerizing the blended liquid biodegradable textile additive and the esterification mixture occurs at a temperature from about 265° C. to about 295° C.

In accordance with certain embodiments, the blended liquid biodegradable textile additive may comprise 50-80 wt % caprolactone monomer. In some embodiments, the blended liquid biodegradable textile additive may comprise 15-25 wt % polyethylene glycol. In certain embodiments, the blended liquid biodegradable textile additive may comprise 0.4-2 wt % ethylene glycol. In further embodiments, the blended liquid biodegradable textile additive may comprise 0.01-1 wt % antioxidant. In some embodiments, the solid system additive may comprise 91-94 wt % polybutylene succinate. In further embodiments, the solid system additive may comprise 6-9 wt % calcium carbonate. In some embodiments, the composition may comprise 0.4-1.2 wt % of the blended liquid biodegradable textile additive. In further embodiments, the composition may comprise 0.1-1.5 wt % solid system additive.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

According to certain embodiments, a method of forming a fabric from the biodegradable polyester copolymer filament may be provided.

According to certain embodiments, a method of forming a textured biodegradable polyester copolymer filament may be provided. The method may comprise texturing the biodegradable polyester copolymer filament to form the textured biodegradable polyester copolymer filament.

In accordance with certain embodiments, a method of forming a textured biodegradable polyester copolymer staple fiber may be provided. The method may comprise cutting the textured biodegradable polyester copolymer filament to form a textured biodegradable polyester copolymer staple fiber.

According to certain embodiments, a method of forming a textured biodegradable polyester chip may be provided. The method may comprise granulizing the textured biodegradable polyester copolymer filament to form a textured biodegradable polyester chip.

In accordance with certain embodiments, a method of forming a textured biodegradable polyester container may be provided. The method may comprise blow-molding the textured biodegradable polyester copolymer to form a textured biodegradable polyester container.

According to certain embodiments, a method of forming a textured biodegradable polyester wrap may be provided. The method may comprise blow-molding the textured biodegradable polyester copolymer to form a textured biodegradable polyester wrap.

In accordance with certain embodiments, a method of forming a textured biodegradable polyester copolymer yarn may be provided. The method may comprise spinning the textured biodegradable polyester copolymer staple fiber to form a yarn.

According to certain embodiments, a method of forming a textured biodegradable polyester copolymer blended yarn may be provided. The method may comprise spinning the textured biodegradable polyester copolymer staple fiber with one or more of cotton fiber and rayon fiber to form a blended yarn.

In accordance with certain embodiments, a method of forming a fabric from the textured biodegradable polyester copolymer staple fiber may be provided. In some embodiments, forming the fabric may comprise knitting the textured biodegradable polyester copolymer staple fiber to form the fabric. In other embodiments, forming the fabric may comprise weaving the textured biodegradable polyester copolymer staple fiber to form the fabric. In further embodiments, forming the fabric may comprise forming a nonwoven fabric. In certain embodiments, a method of forming a garment from the fabric is provided.

In yet another aspect, a kit for spinning a biodegradable polyester copolymer filament is provided. The kit includes a liquid additive container containing a blended liquid biodegradable textile additive, a solid system additive, terephthalic acid, and ethylene glycol. The blended liquid biodegradable textile additive comprises caprolactone monomer, polyethylene glycol, ethylene glycol, and an antioxidant. The solid system additive comprises polybutylene succinate and calcium carbonate.

In accordance with certain embodiments, the blended liquid biodegradable textile additive may comprise 50-80 wt % caprolactone monomer. In some embodiments, the blended liquid biodegradable textile additive may comprise 15-25 wt % polyethylene glycol. In certain embodiments, the blended liquid biodegradable textile additive may comprise 0.4-2 wt % ethylene glycol. In further embodiments, the blended liquid biodegradable textile additive may comprise 0.01-1 wt % antioxidant.

According to certain embodiments, the solid system additive may comprise 91-94 wt % polybutylene succinate. In further embodiments, the solid system additive may comprise 6-9 wt % calcium carbonate. In some embodiments, the kit may comprise 0.4-1.2 wt % of the blended liquid biodegradable textile additive. In further embodiments, the kit may comprise 0.1-1.5 wt % solid system additive.

According to certain embodiments, the polyethylene glycol may comprise a low molecular weight polyethylene glycol. In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800).

In accordance with certain embodiments, the antioxidant may comprise a phenolic antioxidant. In some embodiments, the phenolic antioxidant may be sterically-hindered or partially-hindered.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a liquid additive container in accordance with certain embodiments of the invention;

FIG. 2 illustrates a liquid additive container in accordance with certain embodiments of the invention;

FIGS. 3A and 3B illustrate biodegradation of textiles under ASTM D5210 in accordance with certain embodiments of the invention;

FIGS. 4A, 4B, and 4C illustrate biodegradation of textiles under ASTM D5511 in accordance with certain embodiments of the invention; and

FIG. 5 illustrates biodegradation of textiles under ASTM D5988 in accordance with certain embodiments of the invention.

### DETAILED DESCRIPTION

Embodiments of the present disclosure will now be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

As set forth herein, the present disclosure describes fibers with desirable properties analogous to traditional fibers that are biodegradable and which may be formed via continuous production, rather than masterbatch production. More particularly, a polyester (polyethylene terephthalate or PET) fiber that is biodegradable is disclosed. Also disclosed are components of these fibers that are configured for simplified bulk transport.

Accordingly, a polyester (polyethylene terephthalate) fiber that is biodegradable is described. Typically, to form biodegradable polymers, a masterbatch approach is used with an extruder process. However, masterbatch is costly, requiring additional compounding, drying and crystallization steps, and is thus poorly adopted and biodegradable fibers are not widely available at affordable price points. A continuous polymerization process is more economical for synthesis of polyesters, however, polycaprolactone, a known biodegradable polymer, is in pellet form and is well suited to a masterbatch approach but is ill-adapted for use in continuous polymerization process.

To overcome these difficulties, the present disclosure incorporates caprolactone monomer, a clear liquid, into polyester in a continuous polymerization process. Caprolactone monomer is a precursor to polycaprolactone, which is biodegradable in a natural environment, and imparts other desirable properties into the fiber, such as dye enhancement. The use of caprolactone monomer on conventional continuous polymerization lines results in high throughput with low cost, with outputs exceeding 30,000 pounds per hour, or sometimes about 40,000 pounds per hour or even 60,000 to 90,000 pounds per hour, as compared to a masterbatch approach which limits production throughput to around 2,000 to 4,000 pounds per extruder per hour. In this way, by utilizing the formulations disclosed herein, no carrier polymer is needed, and by the end of the process, three times the amount of fiber achieved by the masterbatch process may be achieved by the continuous polymerization process while also significantly reducing costs in both the materials and processes.

Further, the caprolactone monomer is nearly fully consumed, or approximately fully consumed (e.g., values less than 200 ppm).

To produce the biodegradable polymers of the present disclosure, terephthalic acid (or purified terephthalic acid or PTA) and ethylene glycol (or monoethylene glycol or MEG) are reacted in a heated esterification reaction to produce monomers and oligomers of terephthalic acid and ethylene glycol as well as water as a byproduct. The esterification reaction may be carried out in one or more vessels, in some embodiments two vessels are used, each an estifier. A pressure gradient is conventionally used to drive the continuous polymerization process. Additionally, pumps may be used to drive the process. To enable the esterification reaction to go essentially to completion, water and MEG are continuously removed. The monomers and oligomers formed via esterification are subsequently catalytically polymerized via polycondensation to form polyethylene terephthalate (or PET) polyester. The polycondensation reactions may be carried out in one or more vessels, each a polymerizer. In some embodiments, two vessels are used, a low polymerizer under low vacuum and a high polymerizer under high vacuum, as is known in the art.

Polymerization continues until the desired mole weight of polyester terephthalate is achieved. The residence time in the polymerization vessels and the feed rate of the ethylene glycol and terephthalic acid into the continuous process is determined, in part, based on the target molecular weight of the polyester. As the molecular weight can be determined by the intrinsic viscosity of the polymer melt, the intrinsic viscosity of the polymer melt is generally used to determine polymerization conditions, such as temperature, pressure, the feed rate of the reactants, and the residence time within the polymerization vessels.

Upon completion of the polycondensation stage, the polymer melt may be filtered and extruded. After extrusion, the polyethylene terephthalate is quenched to solidify the polyester, such as by spraying with water. The solidified polyethylene terephthalate may be cut into chips for storage and handling purposes.

In some embodiments, the polyester produced by the method is spun into a filament using conventional techniques known in the art.

In some embodiments, the polyester produced by the method may be blow molded into packaging and other products.

In some embodiments, the filament produced by the method is textured and cut into staple fiber. Texturing is well understood in the art and will not be otherwise described in detail, other than to point out that to date, the composition of the invention produces filament that can be textured using conventional steps (e.g., heat setting while in a twisted position).

In some embodiments, the staple fiber produced by the method is spun into a yarn.

In some embodiments, the staple fiber may be formed into a nonwoven fabric.

In some embodiments, the staple fiber is spun into a blended yarn with cotton or rayon. The yarn may then be used to form a fabric which can be used to create textiles such as garments and the like. The fabric may be woven or knitted, and such fabric used to create textiles and garments. Similarly, the nonwoven fabric may be used to to create garments, other textiles, and the like.

The resulting fibers, filaments, fabrics, containers and the like are biodegradable in a landfill environment, ocean environment, sewer sludge, and in sea water and fresh water, as well as other natural and unnatural environments that comprise microbes. The time scale of biodegradation in exemplary embodiments are comparable to the biodegradation time scales of natural fibers. In some embodiments, degradation of fiber or fabric of the present disclosure is substantially or mostly complete at 3-4 years. In some or other embodiments, degradation of fiber or fabric of the present disclosure is substantially or mostly complete at less than 3 years. In this way, use of the fibers, filaments, fabrics, containers, and the like described herein may significantly reduce the amount of plastic microfiber in the environment via biodegradation.

Caprolactone monomer and calcium carbonate (CaCO₃) are added during the above esterification and polycondensation reactions. In some embodiments, the caprolactone monomer and calcium carbonate may be added directly to the vessel containing the condensation product, e.g., a low polymerizer. In some embodiments, the caprolactone monomer and calcium carbonate may be added to a transfer line between an esterifier and a polymerizer. Concurrently or subsequently, polybutylene succinate (PBS) may be added. The reactions typically proceed at about 280° C. (e.g., between about 265° C. and 295° C.). Caprolactone monomer is incorporated into the polyester fiber along with PBS and calcium carbonate to form a biodegradable polyester material. Microbes digest the resulting fiber containing polycaprolactone, PBS, and calcium carbonate to break down the polymer chains and allow the fibers to biodegrade.

Although the invention is not limited by the mechanism by which calcium carbonate operates, and although the inventors do not wish to be bound by any particular theory, the following hypothesis appears reasonable. The presence of microscopic inorganic particles of calcium carbonate mixed in a homogenous organic polymeric matrix introduces a plethora of nucleation points for biodegradation. This calcium carbonate is dosed simultaneously with other biodegradable ingredients, rendering the nucleation points to be in close proximity with these ingredients. Calcium ions may play an important role in bacterial growth. Calcium binding proteins present in bacteria help in signal transduction and may assist in the important process of positive chemotaxis where the bacteria move towards higher concentrations of a chemical.

According to this hypothesis, the breakdown of the polymer into monomers and oligomers by hydrolysis of the ester linkages by the action of anaerobic bacteria are accelerated by the presence of dispersed calcium carbonate. The presence of carbon dioxide, a metabolic byproduct, can also enhance the dissolution of calcium carbonate present in the polymer matrix.

Another mechanism where calcium and calcium binding proteins in bacteria can play an important role is in quorum sensing; i.e., a means of communication in bacteria optimized for population growth. The individual bacteria work to create a hydrogel, composed of bacteria and extra cellular polymeric materials that create a coordinated functional community. This macroscopic structure magnifies the bacterial action and helps lead to the biodegradation of polymers according to the invention, especially high surface area microfibers that can be incorporated into such a hydrogel.

### Definitions

As used herein, the term “biodegradable” means materials that when given the right natural conditions and presence of microorganisms, will decompose, or break down to its basic components and blend back in with the earth on a significantly faster scale than non-biodegradable materials. For the purposes of this disclosure, a non-biodegradable polymer is one that degrades by 10% or less after 266 days of testing according to ASTM D-5511.

The term “polymers” refers to large molecules (molecular weight over 100 Daltons, typically thousands of Daltons) comprising many repeating units.

A “textile” is a type of material composed of natural and/or synthetic fibers, filaments, or yarn, and may be in knit, woven, or nonwoven forms.

The term “nonwoven fabric” is well understood by the person of ordinary skill in this art, and is used herein consistent with such understanding including definitions such as those in Tortora, Phyllis G., and Robert S. Merkel. Fairchild's Dictionary of Textiles. 7th ed. New York, NY: Fairchild Publications, 2009, page 387. Thus, a nonwoven fabric is, “a textile structure produced by bonding or interlocking of fibers, or both; accomplished by mechanical, chemical, thermal, or solvent means and combinations thereof.” Exemplary methods of forming the basic web include carding fibers, air laying, and wet forming. These webs can be secured or bonded by use of adhesives, including low-melt fibers interspersed among the web, thermal bonding for appropriate thermoplastic polymers, needle punching, spunlacing (hydroentanglement), and spun bonded processes.

The skilled person understands that in the textile arts, the word “spinning” has two different definitions, both of which are clear in context. In forming synthetic filament, the term “spinning” refers to the step of extruding the molten polymer into filament. In the context of natural fibers, or staple fibers cut from textured synthetic filament, the term “spinning” is used in its most historical sense (dating to antiquity) of twisting filaments into a cohesive yarn structure from which fabrics can be woven.

The inventive fibers, yarns, and fabrics can be characterized by their physical properties such as by the ASTM and/or AATCC tests described in the Examples. For instance, the fibers, yarns, and fabrics can be defined by the extent of degradation according to an ASTM test on a basis of mass % biodegradation agent in the fiber. The molecular composition of the precursors, intermediates and final products can be determined by conventional methods such as gel permeation chromatography, more preferably gradient analysis of polymer blends.

ASTM and AATCC testing protocols are considered industry standards. These protocols typically do not change significantly over time; however, if any question arises regarding the dates of these standards, not specified herein, the standard in effect in April 2023 is to be selected.

As used herein, in the context of synthetic fibers and their manufacture, the term “intrinsic viscosity” is used to describe a characteristic that is directly proportional to the average molecular weight of a polymer. Intrinsic viscosity is calculated on the basis of the viscosity of a polymer solution (in a solvent) extrapolated to a zero concentration.

In the textile arts, the term “texturing” is used both broadly and specifically. In the broadest sense, texturing is used as a synonym to refer to steps in which synthetic filament, staple fiber, or yarn is mechanically treated, thermally treated, or both, to have a greater volume then the untreated filament, staple, or yarn. In a narrower sense, the term texturing is used to refer to treatments that produce looping and curling. The meaning is generally clear in context. As used herein, the word “texture” is used in a broad sense to include all possibilities for producing the desired effect in a filament, staple fiber, or yarn.

Where “between” is used to indicate a number range, the range is inclusive of the numbers used. For example, “between about 10% and about 13%” is inclusive of both 10% and 13% as well as all numbers between 10% and 13%.

As used herein, “percent” or “%” means weight percent unless otherwise specified. Further, concentrations and proportions, unless otherwise stated, refer to the concentration or proportion in the finished copolymer.

### Blended Liquid Biodegradable Textile Additive

The invention includes, according to certain embodiments, additives, systems, methods, and kits for forming biodegradable textiles. In particular, according to a first aspect, a blended liquid biodegradable textile additive is provided. In some embodiments, the additive includes caprolactone monomer, polyethylene glycol, calcium carbonate, and an antioxidant. The blended liquid biodegradable textile additive may be formulated for transport in liquid additive containers described herein such that the liquid ingredients may be shipped anywhere in the world due to it being easy to handle, pre-proportioned, and convenient.

In accordance with certain embodiments, the additive may comprise about 50-80 wt % caprolactone monomer (e.g., Ingevity Capa® Monomer). For example, in some embodiments, the additive may comprise about 60-80 wt % caprolactone monomer. In further embodiments, for instance, the additive may comprise about 70-80 wt % caprolactone monomer. In certain embodiments, for example, the additive may comprise about 75 wt % caprolactone monomer. For instance, in accordance with certain embodiments, the additive may comprise at least about any of the following: 50, 51, 52, 53, 54, 55, 56, 57, 58, 59, 60, 61, 62, 63, 64, 65, 66, 67, 68, 69, 70, 71, 72, 73, 74, 75, 76, 77, 78, and 79 wt % and/or at most about 80, 79, 78, 77, 76, 75, 74, 73, 72, 71, 70, 69, 68, 67, 66, 65, 64, 63, 62, 61, 60, 59, 58, 57, 56, 55, 54, 53, 52, and 51 wt % caprolactone monomer (e.g., about 69-77 wt %, about 52-79 wt %, etc.).

In some embodiments, the additive may comprise about 15-25 wt % polyethylene glycol (PEG). For example, in certain embodiments, the additive may comprise about 20-25 wt % PEG. In further embodiments, for instance, the additive may comprise about 21-24 wt % PEG. In some embodiments, for example, the additive may comprise about 22 wt % PEG. For instance, in accordance with certain embodiments, the additive may comprise at least about any of the following: 15, 16, 17, 18, 19, 20, 21, 22, 23, and 24 wt % and/or at most about 25, 24, 23, 22, 21, 20, 19, 18, 17, and 16 wt % PEG (e.g., about 16-24 wt %, about 22-25 wt %, etc.). According to certain embodiments, the polyethylene glycol may comprise a low molecular weight polyethylene glycol. Without intending to be limited by theory, the low molecular weight polyethylene glycol may be a liquid at room temperature (including a warm room temperature in the case of PEG 800). In some embodiments, the polyethylene glycol may comprise polyethylene glycol 200 (PEG 200), polyethylene glycol 400 (PEG 400), polyethylene glycol 600 (PEG 600), or polyethylene glycol 800 (PEG 800). In further embodiments, the polyethylene glycol may comprise polyethylene glycol 400 (PEG 400) (Brenntag).

In certain embodiments, the additive may comprise about 0.4-2 wt % calcium carbonate. For example, in some embodiments, the additive may comprise about 0.8-1.8 wt % calcium carbonate. In further embodiments, for instance, the additive may comprise about 1-1.6 wt % calcium carbonate. In some embodiments, for example, the additive may comprise about 1.5 wt % calcium carbonate. For instance, in accordance with certain embodiments, the additive may comprise at least about any of the following: 0.4, 0.5, 0.6, 0.7, 0.8, 0.9, 1, 1.1, 1.2, 1.3, 1.4, 1.5, 1.6, 1.7, 1.8, and 1.9 wt % and/or at most about 2, 1.9, 1.8, 1.7, 1.6, 1.5, 1.4, 1.3, 1.2, 1.1, 1, 0.9, 0.8, 0.7, 0.6, and 0.5 wt % calcium carbonate (e.g., about 0.7-1.8 wt %, about 1.4-2 wt %, etc.).

The inventive compositions may use fine calcium carbonate powders. The powders may have a mass average particle size of 15 microns (μm) or less, 10 μm or less, in some embodiments 7 μm or less, and may be in the range of a mass average particle size of between 0.1 and 10 μm, or between 1 and 8 μm, or between 5 and 8 μm. As is conventional, particle size can be measured by commercial photoanalysis equipment or other conventional means. The calcium carbonate powder has a surface area of at least 0.5 square meters per gram (m²/g); in some cases at least 1.0 m²/g and in some embodiments between 0.5 and 10 m²/g. As is conventional, surface area can be determined by a method such as the ISO 9277 standard for calculating the specific surface area of solids which in turn is based on the Brunauer-Emmett-Teller (BET) theory.

The calcium carbonate particles may be milled to a size useful for the additive. Expressed functionally, the milled particles can be as small as possible, and very small particles present no disadvantage.

An upper limit of particle size is, however, defined in part by the denier, which the lay person would describe in terms of diameter. In those terms, the average calcium carbonate particle size should be no larger than 10% of the diameter of the extruded filament, and the maximum particle size should be no greater than 20% of the diameter of the extruded filament, because particle sizes greater than about 10% of filament diameter are much more likely to lead to breakage at all phases of production and use. For example, for fine denier fibers the calcium carbonate particles may have a particle size of about 1 to about 1.5 μm, while for more coarse denier fibers the calcium carbonate particles may have a particle size of about 2 to about 4 μm.

As noted above, the lower limit is less critical, with the main consideration being the increased difficulty and cost of producing ever smaller particles.

Thus, as a practical example a one denier (1 D) polyester fiber has a diameter of 10 microns (μm), meaning that the calcium carbonate particle size should not exceed about 1 μm. Skilled persons will be able to select relevant particle sizes based on this general 10% relationship.

In further embodiments, the additive may comprise about 0.01-1 wt % antioxidant. For example, in some embodiments, the additive may comprise about 0.6-0.8 wt % antioxidant. In further embodiments, for instance, the additive may comprise about 0.75-0.8 wt % antioxidant. In certain embodiments, for example, the additive may comprise about 0.77 wt % antioxidant. For instance, in accordance with certain embodiments, the additive may comprise at least about any of the following: 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, and 0.99 wt % and/or at most about 1, 0.99, 0.98, 0.97, 0.96, 0.95, 0.94, 0.93, 0.92, 0.91, 0.9, 0.89, 0.88, 0.87, 0.86, 0.85, 0.84, 0.83, 0.82, 0.81, 0.8, 0.79, 0.78, 0.77, 0.76, 0.75, 0.74, 0.73, 0.72, 0.71, 0.7, 0.69, 0.68, 0.67, 0.66, 0.65, 0.64, 0.63, 0.62, 0.61, 0.6, 0.59, 0.58, 0.57, 0.56, 0.55, 0.54, 0.53, 0.52, 0.51, 0.5, 0.49, 0.48, 0.47, 0.46, 0.45, 0.44, 0.43, 0.42, 0.41, 0.4, 0.39, 0.38, 0.37, 0.36, 0.35, 0.34, 0.33, 0.32, 0.31, 0.3, 0.29, 0.28, 0.27, 0.26, 0.25, 0.24, 0.23, 0.22, 0.21, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, and 0.02 wt % antioxidant (e.g., about 0.55-0.93 wt %, about 0.72-0.78 wt %, etc.). In accordance with certain embodiments, the antioxidant may comprise a phenolic antioxidant. In some embodiments, the phenolic antioxidant may be sterically-hindered (e.g., BASF Irganox® 1010) or partially-hindered (e.g., MayzoR BNX 245). The antioxidant may be included to prevent oxidation of the polyethylene glycol.

In other embodiments, calcium carbonate may not be included in the blended liquid biodegradable textile additive but instead may be added with polybutylene succinate in a solid system additive, as described in more detail below. Instead, calcium carbonate may be replaced with ethylene glycol in the blended liquid biodegradable textile additive. In this way, the ethylene glycol may dissolve the antioxidant such that the blended liquid biodegradable textile additive is a clear liquid. Because the blended liquid biodegradable textile additive is a well-blended clear liquid, the blended liquid biodegradable textile additive does not require constant agitation after the initial mixing and during transit.

In such embodiments, the blended liquid biodegradable textile additive may comprise 50-80 wt % caprolactone monomer. In some embodiments, the blended liquid biodegradable textile additive may comprise 15-25 wt % polyethylene glycol. In further embodiments, the blended liquid biodegradable textile additive may comprise 0.01-1 wt % antioxidant.

In certain embodiments, the blended liquid biodegradable textile additive may comprise 0.4-2 wt % ethylene glycol. For example, in some embodiments, the additive may comprise about 0.8-1.8 wt % ethylene glycol. In further embodiments, for instance, the additive may comprise about 1-1.6 wt % ethylene glycol. In some embodiments, for example, the additive may comprise about 1.5 wt % ethylene glycol. For instance, in accordance with certain embodiments, the additive may comprise at least about any of the following: 0.4, 0.5, 0.6, 0.7, 0.8, 0.9, 1, 1.1, 1.2, 1.3, 1.4, 1.5, 1.6, 1.7, 1.8, and 1.9 wt % and/or at most about 2, 1.9, 1.8, 1.7, 1.6, 1.5, 1.4, 1.3, 1.2, 1.1, 1, 0.9, 0.8, 0.7, 0.6, and 0.5 wt % ethylene glycol (e.g., about 0.7-1.8 wt %, about 1.4-2 wt %, etc.).

### Biodegradable Textile Composition and Method

According to certain embodiments, a biodegradable textile composition may be provided. The biodegradable textile composition may include terephthalic acid, ethylene glycol, the blended liquid biodegradable textile additive, and polybutylene succinate.

In some embodiments, the composition may comprise about 800-10,000 ppm polybutylene succinate (PBS). For example, in certain embodiments the composition may comprise about 1000-1500 ppm PBS. In further embodiments, for instance, the composition may comprise about 1000-1200 ppm PBS. For instance, in accordance with certain embodiments, the composition may comprise at least about any of the following: 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100, 5200, 5300, 5400, 5500, 5600, 5700, 5800, 5900, 6000, 6100, 6200, 6300, 6400, 6500, 6600, 6700, 6800, 6900, 7000, 7100, 7200, 7300, 7400, 7500, 7600, 7700, 7800, 7900, 8000, 8100, 8200, 8300, 8400, 8500, 8600, 8700, 8800, 8900, 9000, 9100, 9200, 9300, 9400, 9500, 9600, 9700, 9800, and 9900 ppm and/or at most about 10,000, 9900, 9800, 9700, 9600, 9500, 9400, 9300, 9200, 9100, 9000, 8900, 8800, 8700, 8600, 8500, 8400, 8300, 8200, 8100, 8000, 7900, 7800, 7700, 7600, 7500, 7400, 7300, 7200, 7100, 7000, 6900, 6800, 6700, 6600, 6500, 6400, 6300, 6200, 6100, 6000, 5900, 5800, 5700, 5600, 5500, 5400, 5300, 5200, 5100, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 1700, 1600, 1500, 1400, 1300, 1200, 1100, 1000, and 900 ppm PBS (e.g., about 1000-7000 ppm, about 900-1300 ppm, etc.).

In further embodiments, the composition may comprise about 0.4-1.2 wt % of the blended liquid biodegradable textile additive. For instance, in some embodiments, the composition may comprise about 0.6-0.8 wt % of the blended liquid biodegradable textile additive. In certain embodiments, for example, the composition may comprise about 0.6-0.7 wt % of the blended liquid biodegradable textile additive. In further embodiments, for instance, the composition may comprise about 0.65 wt % of the blended liquid biodegradable textile additive. For instance, in accordance with certain embodiments, the composition may comprise at least about any of the following: 0.4, 0.45, 0.5, 0.55, 0.6, 0.65, 0.7, 0.75, 0.8, 0.85, 0.9, 0.95, 1, 1.05, 1.1, and 1.15 wt % and/or at most about 1.2, 1.15, 1.1, 1.05, 1, 0.95, 0.9, 0.85, 0.8, 0.75, 0.7, 0.65, 0.6, 0.55, 0.5, and 0.45 wt % additive (e.g., about 0.6-0.9 wt %, about 0.65-0.85 wt %, etc.).

In other embodiments, the biodegradable textile composition may include terephthalic acid, ethylene glycol, the blended liquid biodegradable textile additive, and a solid system additive. The solid system additive may comprise polybutylene succinate and calcium carbonate.

In certain embodiments, the solid system additive may comprise 91-94 wt % polybutylene succinate. In some embodiments, the solid system additive may comprise 92-93 wt % polybutylene succinate. In further embodiments, the solid system additive may comprise about 92.9 wt % polybutylene succinate. For instance, in accordance with certain embodiments, the solid system additive may comprise at least about any of the following: 91, 91.1, 91.2, 91.3, 91.4, 91.5, 91.6, 91.7, 91.8, 91.9, 92, 92.1, 92.2, 92.3, 92.4, 92.5, 92.6, 92.7, 92.8, 92.9, 93, 93.1, 93.2, 93.3, 93.4, 93.5, 93.6, 93.7, 93.8, and 93.9 wt % polybutylene succinate and/or at most about 94, 93.9, 93.8, 93.7, 93.6, 93.5, 93.4, 93.3, 93.2, 93.1, 93, 92.9, 92.8, 92.7, 92.6, 92.5, 92.4, 92.3, 92.2, 92.1, 92, 91.9, 91.8, 91.7, 91.6, 91.5, 91.4, 91.3, 91.2, and 91.1 wt % polybutylene succinate (e.g., about 91.5-93 wt %, about 92-92.9 wt %, etc.).

In certain embodiments, the solid system additive may comprise 6-9 wt % calcium carbonate. In some embodiments, the solid system additive may comprise 7-8 wt % calcium carbonate. In further embodiments, the solid system additive may comprise about 7.1 wt % calcium carbonate. For instance, in accordance with certain embodiments, the solid system additive may comprise at least about any of the following: 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, and 8.9 wt % calcium carbonate and/or at most about 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, and 6.1 wt % calcium carbonate (e.g., about 6.5-8.4 wt %, about 7-8.8 wt %, etc.).

According to certain embodiments, the solid system additive may comprise polybutylene succinate and calcium carbonate at a ratio of about 4:1 to about 20.1. In some embodiments, the solid system additive may comprise polybutylene succinate and calcium carbonate at a ratio of about 4:1-15:1. In further embodiments, the solid system additive may comprise polybutylene succinate and calcium carbonate in a ratio of approximately 13:1. For instance, in accordance with certain embodiments, the solid system additive may comprise polybutylene succinate and calcium carbonate in a ratio from at least about any of the following: 4:1, 5:1, 6:1, 7:1, 8:1, 9:1, 10:1, 11:1, 12:1, 13:1, 14:1, 15:1, 16:1, 17:1, 18:1, and 19:1 and/or at most about 20:1, 19:1, 18:1, 17:1, 16:1, 15:1, 14:1, 13:1, 12:1, 11:1, 10:1, 9:1, 8:1, 7:1, 6:1, and 5:1 (e.g., about 6:1-19:1, about 5:1-15:1, etc.).

In some embodiments, the composition may comprise 0.4-1.2 wt % of the blended liquid biodegradable textile additive. For instance, in some embodiments, the composition may comprise about 0.6-0.8 wt % of the blended liquid biodegradable textile additive. In certain embodiments, for example, the composition may comprise about 0.6-0.7 wt % of the blended liquid biodegradable textile additive. In further embodiments, for instance, the composition may comprise about 0.65 wt % of the blended liquid biodegradable textile additive. For instance, in accordance with certain embodiments, the composition may comprise at least about any of the following: 0.4, 0.45, 0.5, 0.55, 0.6, 0.65, 0.7, 0.75, 0.8, 0.85, 0.9, 0.95, 1, 1.05, 1.1, and 1.15 wt % and/or at most about 1.2, 1.15, 1.1, 1.05, 1, 0.95, 0.9, 0.85, 0.8, 0.75, 0.7, 0.65, 0.6, 0.55, 0.5, and 0.45 wt % additive (e.g., about 0.6-0.9 wt %, about 0.65-0.85 wt %, etc.).

In certain embodiments, the composition may comprise 0.1-1.5 wt % solid system additive. In some embodiments, the composition may comprise 0.1-0.2 wt % solid system additive. In further embodiments, the composition may comprise about 0.14 wt % solid system additive. For example, in accordance with certain embodiments, the composition may comprise at least about any of the following: 0.1, 0.12, 0.14, 0.16, 0.18, 0.2, 0.22, 0.24, 0.26, 0.28, 0.3, 0.32, 0.34, 0.36, 0.38, 0.4, 0.42, 0.44, 0.46, 0.48, 0.5, 0.52, 0.54, 0.56, 0.58, 0.6, 0.62, 0.64, 0.66, 0.68, 0.7, 0.72, 0.74, 0.76, 0.78, 0.8, 0.82, 0.84, 0.86, 0.88, 0.9, 0.92, 0.94, 0.96, 0.98, 1, 1.2, and 1.4 wt % solid system additive and/or at most about 1.5, 1.4, 1.2, 1, 0.98, 0.96, 0.94, 0.92, 0.9, 0.88, 0.86, 0.84, 0.82, 0.8, 0.78, 0.76, 0.74, 0.72, 0.7, 0.68, 0.66, 0.64, 0.62, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, and 0.12 wt % solid system additive (e.g., about 0.12-1.1 wt %, about 0.1-0.8 wt %, etc.).

By including calcium carbonate in the solid system additive rather than in the blended liquid biodegradable textile additive, the calcium carbonate is prevented from precipitating out of the blended liquid biodegradable textile additive. In this way, filtration and biodegradability may be improved.

In yet another aspect, a method of spinning a biodegradable polyester copolymer filament is provided. The method includes esterifying terephthalic acid and ethylene glycol to form an esterification mixture, adding a blended liquid biodegradable textile additive to the esterification mixture, polymerizing the blended liquid biodegradable textile additive and the esterification mixture to form a polymerization mixture, combining extruded polybutylene succinate with either the esterification mixture or the polymerization mixture such that a biodegradable polyester copolymer melt is formed after the polymerization step, and spinning the biodegradable polyester copolymer melt into the biodegradable polyester copolymer filament.

According to certain embodiments, the method may further comprise extruding polybutylene succinate to form the extruded poly butylene succinate. In some embodiments, the polybutylene succinate may be extruded and processed at about 170-260° C. dependent upon any additional additives included in the mixture. The extruded polybutylene succinate may be added from the last stage of esterification through the completed polymerization stages. In this way, after melting the polybutylene succinate in the extruder, the polybutylene succinate may be injected in the polymer stream downstream of the polymerization process. Alternatively, the polybutylene succinate may be added earlier in the process because it is already polymerized and blends in with the other polymers. For example, the polybutylene succinate (as solid polymer pellets) may be added with the other continuous polymerization line raw materials into the paste tank, thereby eliminating the need for an extruder in the continuous polymerization line.

In embodiments in which the solid system additive including both polybutylene succinate and calcium carbonate is used, the polybutylene succinate and calcium carbonate may be compounded during the extrusion process to form the solid system additive. Alternatively, the poly butylene succinate and calcium carbonate may be combined prior to the extrusion process such that the solid system additive may be added at one time. In either of these alternative scenarios, the solid system additive may be added to the continuous polymerization line via a side stream extruder.

In some embodiments, adding the blended liquid biodegradable textile additive to the esterification mixture may comprise dispensing the blended liquid biodegradable textile additive from a liquid additive container. The blended liquid biodegradable textile additive may be added between the last stage of esterification through the initial stages of polymerization. In this way, the polyethylene glycol and caprolactone monomer in the blended liquid biodegradable textile additive may undergo the required polymerization without unnecessary esterification.

In certain embodiments, polymerizing the blended liquid biodegradable textile additive and the esterification mixture may be carried out on a continuous polymerization line. In other embodiments, polymerizing the blended liquid biodegradable textile additive and the esterification mixture may be carried out on a batch reactor. In some embodiments, polymerizing the blended liquid biodegradable textile additive and the esterification mixture occurs at a temperature from about 265° C. to about 295° C.

Those having ordinary skill in the art recognize that other kinds of additives can be incorporated into the polymers of the present invention. By way of non-limiting example, anatase titanium dioxide, one or more optical brighteners, and blue pigment may be added. Such additives include, without limitation, delusterants, preform heat-up rate enhancers, friction-reducing additives, UV absorbers, inert particulate additives (e.g., clays or silicas), colorants, pigments, antioxidants, branching agents, oxygen barrier agents, carbon dioxide barrier agents, oxygen scavengers, flame retardants, crystallization control agents, acetaldehyde reducing agents, impact modifiers, catalyst deactivators, melt strength enhancers, anti-static agents, lubricants, chain extenders, nucleating agents, solvents, fillers, and plasticizers.

In some embodiments, the fibers in the yarns or textiles may have a denier per filament (dpf) in the range of 0.5 to 50 or 2 to 30, or as high as 1,000. The denier of the fibers is not believed to be critical in the biodegradability because the fibrous textiles will generally have sufficient surface area to support bacterial growth.

The textiles preferably have a dimensional stability such that the textile maintains its shape and shrinks by less than 10%, or less than 5%, or less than 3%, as measured by Home Laundering Test AATCC 135-2015 1IIAii (machine wash at 80 F, tumble dry, five laundering cycles).

The textiles or fibers may be colored (such as red, blue, green, etc.) and preferably possess a colorfastness of at least Grade 3, or at least Grade 4, or Grade 5 as measured by AATCC 61-2013 2A (mod 105 F) or AATCC 8-2016, or AATCC 16.3-2014 (Option 3, 20 AFU). A sheet of the textile (for example a fabric sample cut from a shirt or pants) preferably has a bursting strength of at least 20 psi, preferably at least 50 psi, or at least 100 psi, or in the range of 50 to about 200 psi, or 50 to about 150 psi, where bursting strength is measured 30 according to ASTM D3786/D3886M-13.

In some embodiments, the fabrics have no pilling or fuzziness (Grade 5 according to ASTM D 3512M-16).

In some embodiments, the textile wicks water; this is especially desirable in clothing in which sweat is wicked away from the wearer; in some embodiments the fabric wicks water over a distance of at least 10 mm or at least 20 mm, or in the range of about 10 or about 20 mm to about 150 mm in 2 minutes; as measured by AATCC 197-2013.

The skilled person will also understand that in some embodiments the compositions disclosed herein may be in the form of a molten intermediate, and the melt can be extruded in the form of either pellets or filament in the most common textile applications. Extruding and quenching the melt as pellets provides the opportunity to store, ship, and re-melt the pellets at a different location; e.g. at a customer's location.

When quenched filaments from the composition can be textured using techniques well understood by the skilled person, following which fabric can be formed directly from the textured filament (“filament yarn”), or the textured filament can be cut into staple fiber. Such staple fiber can in turn be spun into a yarn, most commonly in an open-end system, but obviously ring-spinning as well. The yarn can in turn be formed into fabrics (woven, knitted, nonwoven) or can be blended with another polymer (e.g., rayon), or with natural fiber (cotton or wool) to form a blended yarn which in turn can be made into fabrics having the characteristic of the blended fibers.

The invention also includes blended intermediates, fibers, yarns, and textiles. Examples of finished products according to the present invention include: knit fabrics, woven fabrics, nonwoven fabrics, apparel, upholstery, carpeting, bedding such as sheets or pillowcases, industrial use fabrics for agriculture or construction. Examples of apparel include: shirts, pants, bras, panties, hats undergarments, coats, skirts, dresses, tights, stretch pants, and scarves.

For example, in accordance with certain embodiments, a biodegradable polyester copolymer filament made from the biodegradable textile composition may be provided. According to certain embodiments, a textured biodegradable polyester copolymer filament made from the biodegradable polyester copolymer filament may be provided. In accordance with certain embodiments, a textured biodegradable polyester copolymer staple fiber made from the textured biodegradable polyester copolymer filament may be provided. According to certain embodiments, a fabric made from the textured biodegradable polyester copolymer staple fiber may be provided. In some embodiments, the fabric may be a woven fabric. In certain embodiments, the fabric may be a knitted fabric. In further embodiments, the fabric may be a nonwoven fabric. In accordance with certain embodiments, a garment made from the fabric may be provided. According to certain embodiments, a fabric made from the biodegradable polyester filament may be provided.

Further, according to certain embodiments, a method of forming a fabric from the biodegradable polyester copolymer filament may be provided. According to certain embodiments, a method of forming a textured biodegradable polyester copolymer filament may be provided. The method may comprise texturing the biodegradable polyester copolymer filament to form the textured biodegradable polyester copolymer filament. In accordance with certain embodiments, a method of forming a textured biodegradable polyester copolymer staple fiber may be provided. The method may comprise cutting the textured biodegradable polyester copolymer filament to form a textured biodegradable polyester copolymer staple fiber. According to certain embodiments, a method of forming a textured biodegradable polyester chip may be provided. The method may comprise granulizing the textured biodegradable polyester copolymer filament to form a textured biodegradable polyester chip. In accordance with certain embodiments, a method of forming a textured biodegradable polyester container may be provided. The method may comprise blow-molding the textured biodegradable polyester copolymer to form a textured biodegradable polyester container. According to certain embodiments, a method of forming a textured biodegradable polyester wrap may be provided. The method may comprise blow-molding the textured biodegradable polyester copolymer to form a textured biodegradable polyester wrap. In accordance with certain embodiments, a method of forming a textured biodegradable polyester copolymer yarn may be provided. The method may comprise spinning the textured biodegradable polyester copolymer staple fiber to form a yarn. According to certain embodiments, a method of forming a textured biodegradable polyester copolymer blended yarn may be provided. The method may comprise spinning the textured biodegradable polyester copolymer staple fiber with one or more of cotton fiber and rayon fiber to form a blended yarn. In accordance with certain embodiments, a method of forming a fabric from the textured biodegradable polyester copolymer staple fiber may be provided. In some embodiments, forming the fabric may comprise knitting the textured biodegradable polyester copolymer staple fiber to form the fabric. In other embodiments, forming the fabric may comprise weaving the textured biodegradable polyester copolymer staple fiber to form the fabric. In further embodiments, forming the fabric may comprise forming a nonwoven fabric. In certain embodiments, a method of forming a garment from the fabric is provided.

As used herein the term “nap” as well as “napping” or “napped” refer to the well-understood finishing step for manufactured textiles e.g., Tortora, supra at pages 378-79. In this context, the invention is also useful in polar fleece; i.e. the soft napped insulating fabric typically made from polyester.

When formed into appropriate filament, the compositions according to the invention are expected to work very well as the filling for insulated garments.

The nature, structure, and many variations of insulated garments are well understood to the skilled person. Basically, an insulating material is enclosed in a lightweight shell, for which low denier nylon is typical, often including a water repellent treatment that can withstand at least some precipitation.

Down is of course the best insulating material based on weight-for-weight compressibility, loft, and warmth-to-weight ratio, but synthetic fillers such as the present invention offer lower cost, and better insulating properties when wet, even though slightly heavier and slightly less compressible.

As another example, filaments, fibers and yarns according to the invention are expected to perform very well as a biodegradable carpet, or portions of such carpets. As well understood by the skilled person, a carpet is a textile floor covering typically formed of pile yarns or tufting yarns attached to a backing. Prior to the advent of synthetic materials, and still used currently, typical pile was made from wool and the backing was made of a woven fabric into which the yarn could be woven, tufted or otherwise attached.

The skilled person typically uses the terms “carpet” and “rug” interchangeably although in some context a “carpet” covers an entire room (“wall-to-wall carpeting”) and a “rug” covers an area smaller than a full room.

Because synthetic material such as nylon, polypropylene, polyester, and blends of these with wool are useful carpet materials, fibers or yarns formed from the invention are entirely appropriate and useful for carpeting. The skilled person recognizes a wide variety of backing materials, backing structures, and means of attaching pile or tuft to the backing. Repeating all such possibilities would be redundant rather than clarifying and the skilled person can adopt the necessary materials and steps in any given context and without undue experimentation.

### Transport System, Method, and Kit

In another aspect, a system of transporting a blended biodegradable textile additive is provided. The system includes a liquid additive container and a blended liquid biodegradable textile additive disposed in the liquid additive container.

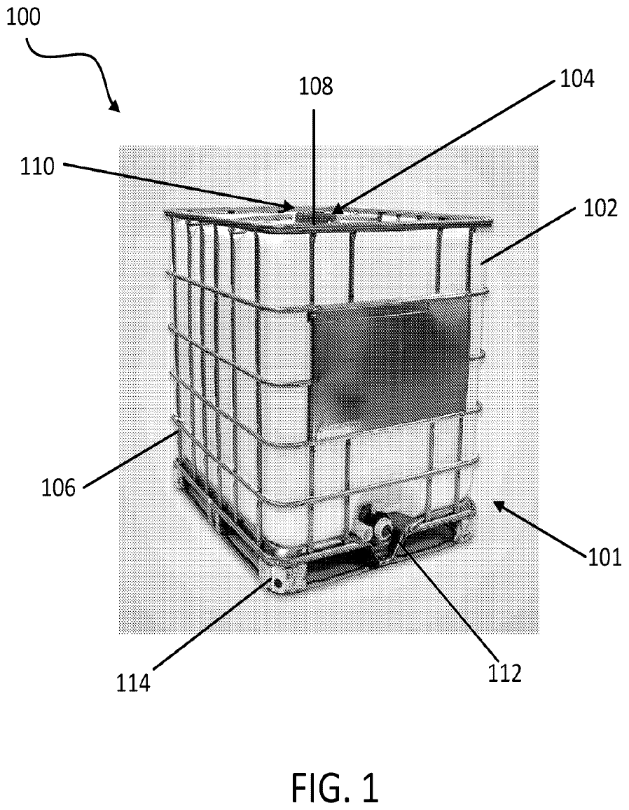

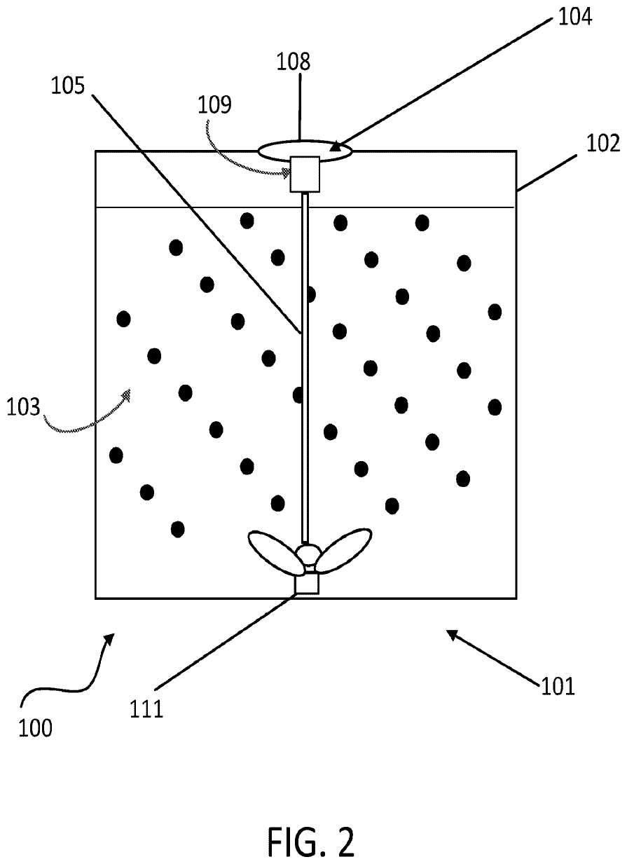

With reference to FIGS. 1 and 2, a system of transporting a blended biodegradable textile additive 100 is illustrated. As described herein, embodiments of the blended biodegradable textile additive transportation system 100 may include a liquid additive container 101 configured to hold and transport a blended biodegradable textile additive 103. As described herein, embodiments of the blended biodegradable textile additive transportation system 100 may include a plastic container 102 having an open end 104, a steel cage 106 housing the plastic container 102, a lid 108 removably coupled to the open end 104 of the plastic container 102, and a valve 112 disposed in a wall of the plastic container 102. The plastic container 102 may also include an agitator propeller 111 disposed at or near the bottom of the plastic container 102 opposite the open end 104 and lid 108 such that the agitator propeller 111 operates just above the bottom of the plastic container 102 (e.g., 1 to 2 inches above the bottom) to keep solid matter off the bottom and in a good suspension. The agitator propeller 111 may comprise a high-shear propeller blade (e.g., about 5 inches in diameter) connected to and powered by an electric agitator drive motor 109 via a shaft 105. The valve 112 may be configured to release the blended liquid biodegradable textile additive 103 from the plastic container 102. In some embodiments, the valve 112 may be a ball valve. In further embodiments, the liquid additive container 101 may be mounted on a pallet 114. In some embodiments, the pallet 114 may comprise plastic (e.g., mid- to high-density polyethylene).

In yet another aspect, a method of transporting a blended liquid biodegradable textile additive is provided. The method includes forming a blended liquid biodegradable textile additive, transferring the blended liquid biodegradable textile additive to a liquid additive container having a lid and a propeller disposed on an interior-facing surface of the lid, placing the liquid additive container containing the blended liquid biodegradable textile additive therein on a transport vehicle, and agitating the blended liquid biodegradable textile additive via the propeller during transport. In embodiments in which the solid system additive is used and calcium carbonate is replaced with ethylene glycol in the blended liquid biodegradable textile additive, continuous agitation may be used but may not be required because the ethylene glycol dissolves the antioxidant such that the blended liquid biodegradable textile additive is a clear liquid, as discussed previously herein.

According to certain embodiments, forming the blended liquid biodegradable textile additive may comprise blending the caprolactone monomer, polyethylene glycol, calcium carbonate, and the antioxidant under agitation. For example, in some embodiments, the caprolactone monomer, polyethylene glycol, calcium carbonate, and the antioxidant may be added to a large (e.g., 2000 gallon) mix tank having a high shear mixing blade (e.g., 3-4 foot diameter) and agitated to put the components in suspension prior to adding the blended liquid biodegradable textile additive to liquid additive containers. In other embodiments, forming the blended liquid biodegradable textile additive may comprise blending the caprolactone monomer, polyethylene glycol, ethylene glycol, and antioxidant under agitation in the same manner described above for the embodiment in which the blended liquid biodegradable textile additive includes calcium carbonate. In some embodiments, transferring the blended liquid biodegradable textile additive to the liquid additive container may comprise pumping the blended liquid biodegradable textile additive into the liquid additive container.

In yet another aspect, a kit for spinning a biodegradable polyester copolymer filament is provided. In some embodiments, the kit may include a liquid additive container containing a blended liquid biodegradable textile additive including calcium carbonate, polybutylene succinate, terephthalic acid, and ethylene glycol. In other embodiments, the kit may include a liquid additive container containing a blended liquid biodegradable textile additive including ethylene glycol rather than calcium carbonate, terephthalic acid, ethylene glycol, and a solid system additive including polybutylene succinate and calcium carbonate.

### Example 1: System and Method of Transporting Blended Liquid Biodegradable Textile Additive

Caprolactone monomer (Ingevity Capa® Monomer), polyethylene glycol 400 (PEG 400, Brenntag), antioxidant (Mayzo® BNX 245), and calcium carbonate in the amounts shown in Table 1 were blended in a mixing tank under agitation and transferred to a 275-gallon polyethylene container via pump. The 275-gallon container holds 2204.6 bs 1 MT total liquid. The container had an agitator port for stirring and included a ball valve for liquid discharge. The container was mounted on a plastic pallet with a protective cage surrounding the body of the container.

TABLE 1

| Blended Liquid for CP | | |
|---|---|---|
| Injection Liquid Container - | % of Liquid | Ingredient lbs |
| Blending for 275 gallon capacity | in Container | in Container |
| CAPA Monomer | 75.38 | 1661.93 |
| PEG 400 | 22.31 | 491.79 |
| Mayzo 245 | 0.77 | 16.96 |
| Calcium Carbonate | 1.54 | 33.92 |

Approximately 65 pph of the liquid blend was fed into a continuous polymerization line, which was running at 10,000 pph and was directly coupled to the fiber spinning machine.

### Example 2: System and Method of Transporting Blended Liquid Biodegradable Textile Additive for Combination with Solid System Additive

Caprolactone monomer (Ingevity Capa® Monomer), polyethylene glycol 400 (PEG 400, Brenntag), and ethylene glycol (“MEG”, Dow) were blended at room temperature, and antioxidant (MayzoR BNX 245) was dissolved in the blended room temperature liquid, all in the amounts shown in Table 2. The components were then blended in a mixing tank under agitation and transferred to a 275-gallon polyethylene container via pump. The 275-gallon container holds 2204.6 bs 1 MT total liquid. The container had an agitator port for stirring and included a ball valve for liquid discharge. The container was mounted on a plastic pallet with a protective cage surrounding the body of the container.

TABLE 2

| Component | % Recipe Contents | Lbs in 1MT Tote |
|---|---|---|
| CAPA Monomer | 77.1 | 1699.7 |
| PEG 400 | 22.1 | 487.2 |
| Mayzo 245 | 0.15 | 3.3 |
| MEG | 0.65 | 14.3 |

As discussed previously herein, this liquid blend was combined with a solid system additive. Polybutylene succinate (Mitsubishi BioPBS™ FZ) and calcium carbonate (Specialty Minerals Inc. SUPER-PFLEX®) in the amounts shown in Table 3 were compounded with underwater pelletization. The pellets were then dried to <1500 ppm water and classified to remove defects.

TABLE 3

| | % Recipe | Lbs in 500 lb Compounded |
|---|---|---|
| Component | Contents | Solid System Additive |
| BioPBS FZ | 92.9 | 464.3 |
| CaCO₃ SUPER-PFLEX | 7.1 | 35.7 |

Approximately 65 pph of the liquid blend was fed, along with the solid system additive fed at 14 pph via a side stream extruder, into a continuous polymerization line, which was running at 10,000 pph and was directly coupled to the fiber spinning machine.

### Example 3: Biodegradability of Textile Compositions ASTM D5210

The sample textile underwent anaerobic biodegradation testing under anaerobic conditions using an anaerobic digested sewage sludge inoculum according to ASTM D5210 to measure the total carbon dioxide and methane gas over time, as well as the soluble organic carbon and residual polymer weight at the end of the test in order to determine biodegradability. The inoculum used to generate the data in Table 4 below was obtained from a hot, dry environment less conducive to microbial activity.

TABLE 4

| | Inoculum | Negative | Positive | Control | Sample |
|---|---|---|---|---|---|
| Cumulative Gas Volume (mL) | 1257.1 | 1459.1 | 9279.3 | 1417.5 | 5236.6 |
| Percent CH₄ (%) | 46.8 | 42.1 | 37.8 | 35.7 | 50.2 |
| Volume CH₄ (mL) | 587.9 | 614.9 | 3511.7 | 506.0 | 2626.7 |
| Mass CH₄ (g) | 0.42 | 0.44 | 2.51 | 0.36 | 1.88 |
| Percent CO₂ (%) | 39.0 | 39.1 | 43.2 | 42.5 | 38.7 |
| Volume CO₂ (mL) | 490.4 | 571.2 | 4008.9 | 601.8 | 2026.7 |
| Mass CO₂ (g) | 0.96 | 1.12 | 7.87 | 1.18 | 3.98 |
| Sample Mass (g) | 10 | 10 | 10 | 20.0 | 20.0 |
| Theoretical Sample Mass (g) | 0.0 | 8.6 | 4.2 | 12.5 | 12.5 |
| Biodegraded Mass (g) | 0.58 | 0.64 | 4.03 | 0.59 | 2.49 |
| Percent Biodegraded (%) | | 0.7 | 81.8 | 0.1 | 15.4 |
| *Adjusted Percent | | 0.8 | 100.0 | 0.2 | 18.8 |
| Biodegraded (%) | | | | | |

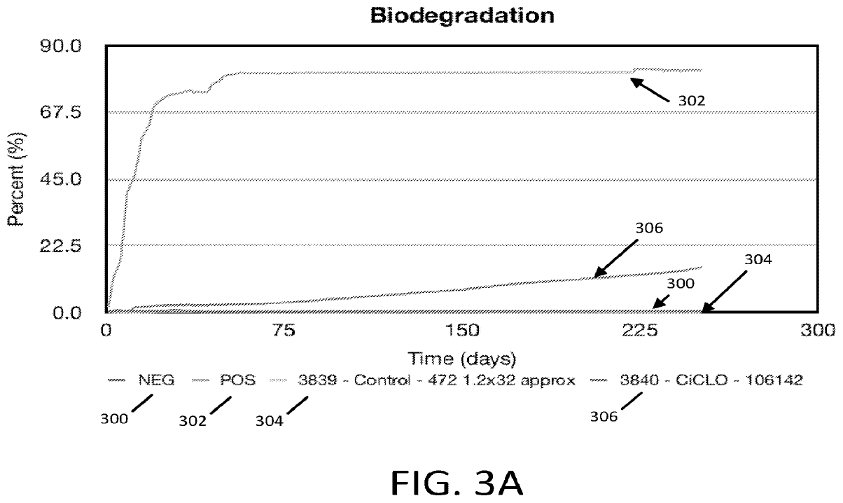

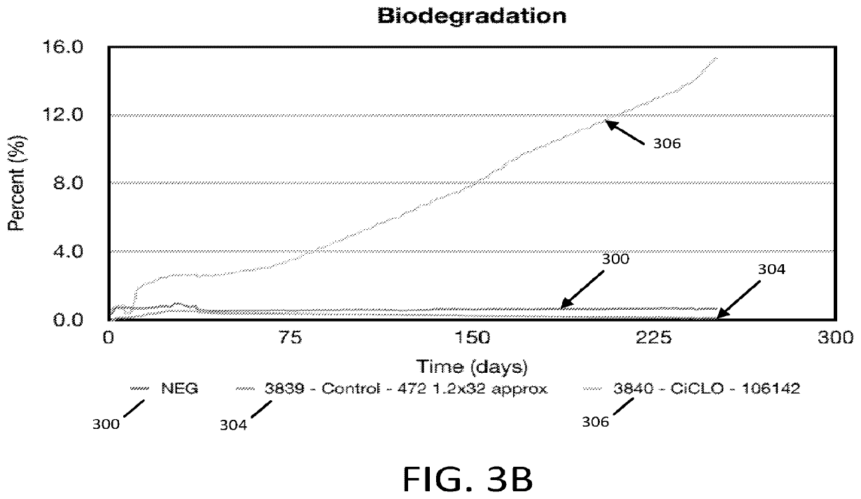

As shown in FIGS. 3A and 3B, following the positive reference material 302 (cellulose), the sample textile 306 showed a significant amount of biodegradation over both the negative control 300 (polypropylene) and the control polyester textile 304. Moreover, FIG. 3B illustrates that the sample textile 306 continued degrading over a significant period of time relative the negative control 308 and the control polyester textile 304.

### ASTM D5511

The sample textile also underwent anaerobic biodegradation testing under high-solids anaerobic conditions using an anaerobic digested sewage sludge inoculum according to ASTM D5511 to determine the percent of conversion of carbon from the test material to carbon in the gaseous phase (CH₄ and CO₂). The inoculum used to generate the data in Table 5 below was obtained from a hot, dry environment less conducive to microbial activity.

TABLE 5

| | Inoculum | Negative | Positive | Control | Sample |
|---|---|---|---|---|---|
| Cumulative Gas Volume (mL) | 2214.9 | 1912.6 | 10443.8 | 2310.6 | 7019.6 |
| Percent CH₄ (%) | 46.6 | 40.3 | 35.2 | 41.1 | 45.4 |
| Volume CH₄ (mL) | 1031.7 | 770.3 | 3673.1 | 949.3 | 3183.8 |
| Mass CH₄ (g) | 0.74 | 0.55 | 2.62 | 0.68 | 2.27 |
| Percent CO₂ (%) | 39.0 | 38.9 | 44.9 | 39.7 | 37.8 |
| Volume CO₂ (mL) | 864.3 | 744.7 | 4688.5 | 918.3 | 2652.2 |
| Mass CO₂ (g) | 1.70 | 1.46 | 9.21 | 1.80 | 5.21 |
| Sample Mass (g) | 10 | 10 | 10 | 20.0 | 20.0 |
| Theoretical Sample Mass (g) | 0.0 | 8.6 | 4.2 | 12.5 | 12.5 |
| Biodegraded Mass (g) | 1.02 | 0.81 | 4.48 | 1.00 | 3.13 |
| Percent Biodegraded (%) | | −2.4 | 82.1 | −0.1 | 16.9 |
| *Adjusted Percent | | −2.9 | 100.0 | −0.1 | 20.6 |
| (Biodegraded %) | | | | | |

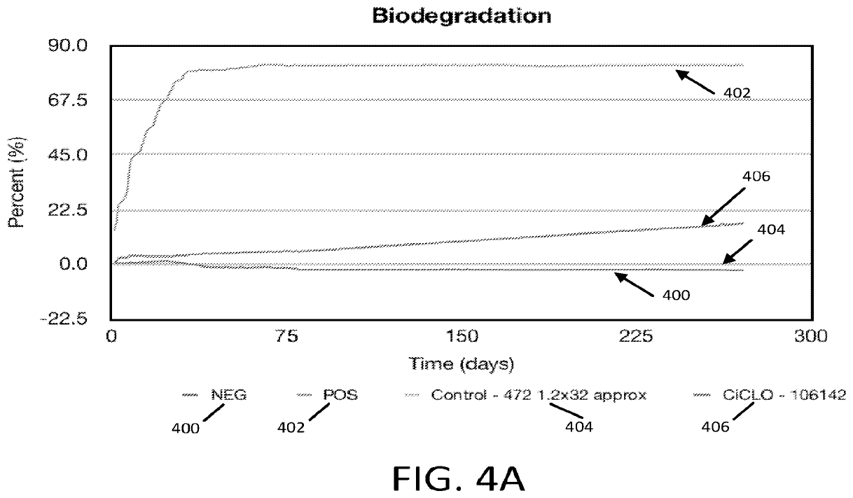

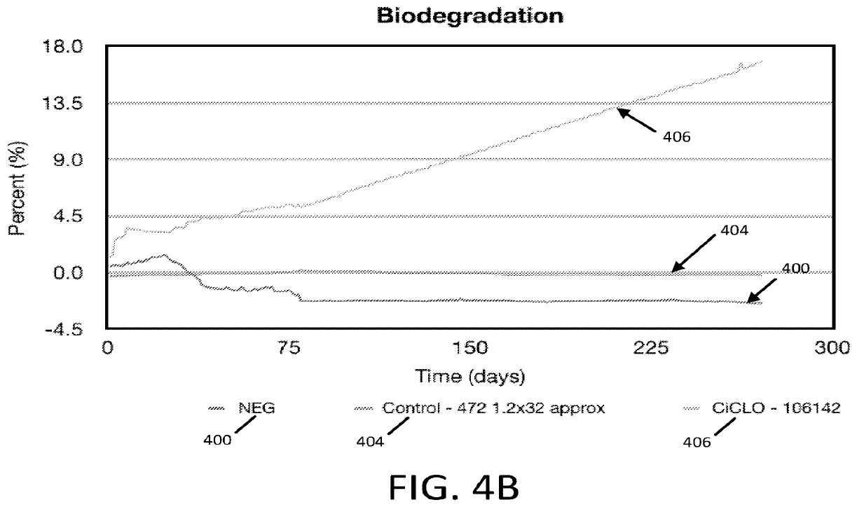

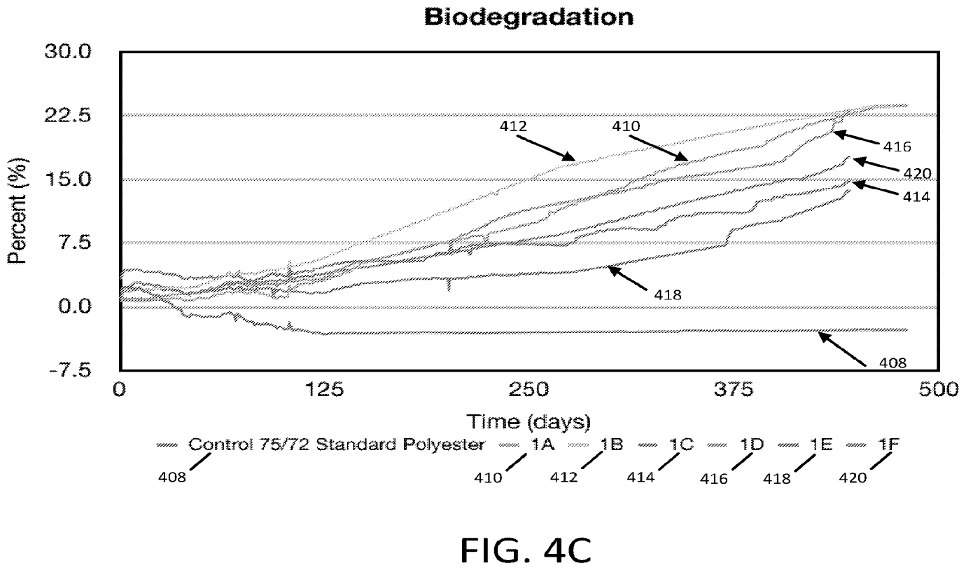

As shown in FIGS. 4A and 4B, following the positive reference material 402 (cellulose), the sample textile 406 showed a significant amount of biodegradation over both the negative control 400 (polypropylene) and the control polyester textile 404. Moreover, FIG. 4B illustrates that the sample textile 406 continued degrading over a significant period of time relative the negative control 400 and the control polyester textile 404.

In contrast to the results shown in Table 5 above, the results shown in Table 6 below were obtained using an anaerobic digested sewage sludge inoculum from a hot, humid atmosphere more conducive to microbial activity.

TABLE 6

| | Inoculum | Positive | Sample | Control |
|---|---|---|---|---|
| Mass (g) | 1000 | 10.1205 | 10.0275 | 10.0231 |
| Total Volume (mL) | 3890.00 | 10110.00 | 8450.00 | 3910.00 |
| Percent CH₄ (%) | 15.50 | 45.20 | 29.60 | 15.70 |
| Volume CH₄ (mL) | 602.95 | 4569.72 | 2501.20 | 613.87 |
| Mass CH₄ (g) | 0.3955 | 2.9977 | 1.6408 | 0.4027 |
| Percent CO₂ (%) | 19.10 | 46.70 | 30.50 | 18.20 |
| Volume CO₂ (mL) | 544.18 | 4721.37 | 2577.25 | 711.62 |
| Mass CO₂ (g) | 1.0775 | 9.3483 | 5.1030 | 1.4090 |
| Total Mass of Carbon | 0.5876 | 4.7723 | 2.6084 | 0.6825 |
| (g) | | | | |
| Theoretical Mass of | | 4.2577 | 6.2002 | 6.1991 |
| Carbon (g) | | | | |
| Biodegraded Mass (g) | | 0.9998 | 0.3259 | 0.0153 |
| Percent Biodegraded | | 99.98 | 32.59 | 1.53 |
| (%) | | | | |

As can be seen in Table 6 above, following the positive reference material (cellulose), the sample textile showed a significant amount of biodegradation over the control polyester textile.

With reference to Table 7, various example sample compositions of the present disclosure are illustrated that were also subjected to biodegradation testing under ASTM D5511. The results of the testing of these example compositions are illustrated in FIG. 4C. As would be evident to one of ordinary skill in the art in light of the present disclosure, the components (e.g., Caprolactone Monomer, PBS, and calcium carbonate) of the sample additives listed in Table 7 represent only a portion of the fibers produced with these additives. For example, a value of 4.9 g of Caprolactone Monomer in the additive may represent 0.0049 wt % in the fiber produced from this additive. This relationship between the values listed in Table 7 and the wt % in the fiber may be applicable to each of the components listed in Table

TABLE 7

| | Caprolactone | Polybutylene | |
|---|---|---|---|
| Sample | Monomer | Succinate (PBS) | CaCO₃ |
| 1-A | 4.9 g | 1.0 g | 0.10 g |
| 1-B | 4.9 g | 1.5 g | 0.20 g |
| 1-C | 4.9 g | 1.5 g | 0.20 g |
| 1-D | 4.9 g | 2.0 g | 0.20 g |
| 1-E | 10.0 g | 1.5 g | 0.15 g |
| 1-F | 10.0 g | 1.5 g | 0.15 |

As shown in FIG. 4C, each of the tested samples (e.g., Samples 1-A 410, Sample 1-B 412, Sample 1-C 414, Sample 1-D 416, Sample 1-E 418, and Sample 1-F 420) showed a significant amount of biodegradation over the control standard polyester 408.

### ASTM D5988

The sample textile further underwent aerobic biodegradation testing in a soil inoculum according to ASTM D5988 to measure the carbon dioxide (CO₂) evolved by microbes over time. The soil inoculum used to generate the data in Table 8 below was obtained from a hot, dry environment less conducive to microbial activity.

TABLE 8

| | Inoculum | Negative | Positive | Control | Sample |
|---|---|---|---|---|---|
| AVG Sample | 300.0 | 400.0 | 1000.0 | 400.0 | 400.0 |
| Weight (mg) | | | | | |
| Total AVG C | 1170.1 | 1166.2 | 1556.3 | 1166.9 | 1231.8 |
| Recovered | | | | | |
| Background | | −3.9 | 386.3 | −3.2 | 61.8 |
| Corrected | | | | | |
| Theoretical Carbon | | 342.8 | 442.0 | 249.2 | 250.0 |
| % Biodegraded | | −1.1 | 87.4 | −1.3 | 24.7 |

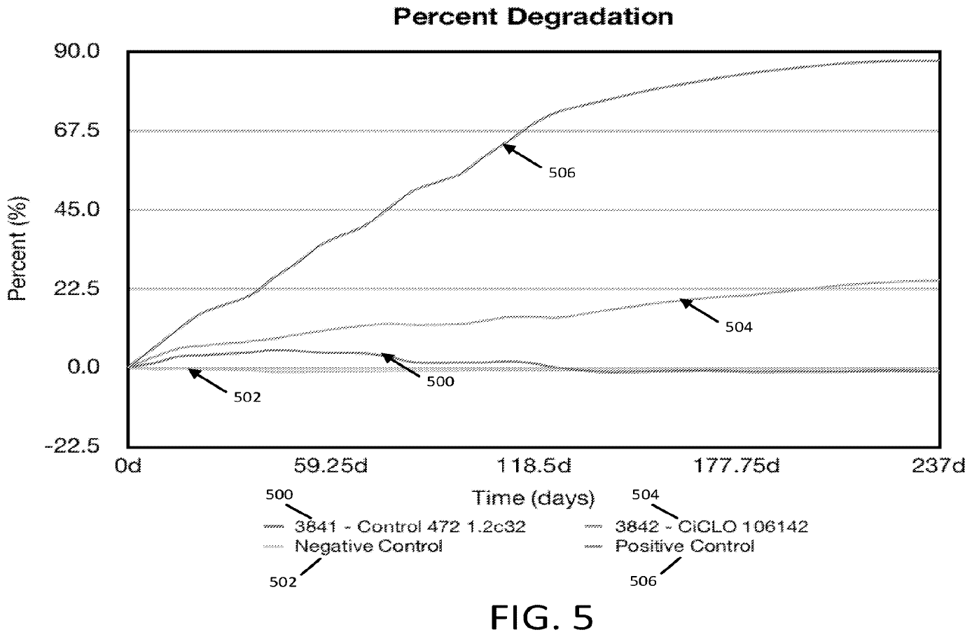

As shown in FIG. 5, following the positive reference material 506 (cellulose), the sample textile 504 showed a significant amount of biodegradation over both the negative control 502 (polypropylene) and the control polyester textile 500, which continued over a period of time.

### ISO 19679

The sample textile further underwent aerobic biodegradation testing in a seawater and sand inoculum according to ISO 19679 to measure the carbon dioxide (CO₂) evolved by microbes over time. Table 9 below summarizes the results of this testing.

TABLE 9

| | Percentage Biodegradation | | |
|---|---|---|---|
| Day | Cellulose | Sample | Control |
| 90 | 55.70 | 8.50 | 0.30 |
| 180 | 89.80 | 18.40 | 0.60 |

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A blended liquid biodegradable textile additive comprising:
caprolactone monomer;
polyethylene glycol;
calcium carbonate; and
an antioxidant.

2. The blended liquid biodegradable textile additive of claim 1, wherein the additive comprises 50-80 wt % caprolactone monomer.

3. The blended liquid biodegradable textile additive of claim 1, wherein the additive comprises 15-25 wt % polyethylene glycol.

4. The blended liquid biodegradable textile additive of claim 1, wherein the additive comprises 0.4-2 wt % calcium carbonate.

5. The blended liquid biodegradable textile additive of claim 1, wherein the additive comprises 0.01-1 wt % antioxidant.

6. (canceled)

7. The blended liquid biodegradable textile additive of claim 1, wherein the polyethylene glycol comprises polyethylene glycol 200 (PEG 200), polyethylene glycol 400 (PEG 400), polyethylene glycol 600 (PEG 600), or polyethylene glycol 800 (PEG 800).

8. The blended liquid biodegradable textile additive of claim 1, wherein the antioxidant comprises a phenolic antioxidant.

9. The blended liquid biodegradable textile additive of claim 8, wherein the phenolic antioxidant is sterically-hindered or partially-hindered.

10. A biodegradable textile composition comprising:
terephthalic acid;
ethylene glycol;
the blended liquid biodegradable textile additive of claim 1; and
polybutylene succinate.

11. The biodegradable textile composition of claim 10, wherein the composition comprises 800-10,000 ppm polybutylene succinate.

12. The biodegradable textile composition of claim 10, wherein the composition comprises 0.4-1.2 wt % of the blended liquid biodegradable textile additive.

13.-22. (canceled)

23. A system of transporting a blended biodegradable textile additive, the system comprising:
a liquid additive container; and
a blended liquid biodegradable textile additive disposed in the liquid additive container, the additive comprising:
caprolactone monomer;
polyethylene glycol;
calcium carbonate; and
an antioxidant.

24. The system of claim 23, wherein the liquid additive container comprises:
a plastic container having an open end;
a steel cage housing the plastic container;
a lid removably coupled to the open end of the plastic container, wherein the lid has an exterior-facing surface and an interior-facing surface, and wherein a propeller is disposed on the interior-facing surface of the lid; and
a valve disposed in a wall of the plastic container configured to release the blended liquid biodegradable textile additive from the plastic container.

25. (canceled)

26. The system of claim 23, wherein the additive comprises 50-80 wt % caprolactone monomer.

27. The system of claim 23, wherein the additive comprises 15-25 wt % polyethylene glycol.

28. The system of claim 23, wherein the additive comprises 0.4-2 wt % calcium carbonate.

29.-86. (canceled)

87. A blended liquid biodegradable textile additive comprising:
caprolactone monomer;
polyethylene glycol;
ethylene glycol; and
an antioxidant.

88. The blended liquid biodegradable textile additive of claim 87, wherein the blended liquid biodegradable textile additive comprises 50-80 wt % caprolactone monomer.

89. The blended liquid biodegradable textile additive of claim 87, wherein the blended liquid biodegradable textile additive comprises 15-25 wt % polyethylene glycol.

90. The blended liquid biodegradable textile additive of claim 87, wherein the blended liquid biodegradable textile additive comprises 0.4-2 wt % ethylene glycol.

91. The blended liquid biodegradable textile additive of claim 87, wherein the blended liquid biodegradable textile additive comprises 0.01-1 wt % antioxidant.

92.-178. (canceled)
